(19) United States
(12) Patent Application Publication
(10) Pub. No.: US 2018/0220677 A1
(43) Pub. Date: Aug. 9, 2018

(54) GRANULAR SOLID COMPOSITION COMPRISING TANNIN, ITS PRODUCTION PROCESS AND ITS USES IN ANIMAL FEED AND AGRICULTURE

(71) Applicant: PROPHOS CHEMICALS SRL, San Giovanni In Croce (CR) (IT)

(72) Inventor: Marco Michelotti, San Giovanni In Croce (CR) (IT)

(21) Appl. No.: 15/744,411

(22) PCT Filed: Jul. 21, 2016
(86) PCT No.: PCT/IB2016/054336

§ 371 Date: Jan. 12, 2018

(30) Foreign Application Priority Data
Jul. 24, 2015 (IT) 102015000037950

(51) Int. Cl. A23K 10/37; A23K 20/111; A23K 40/10; A23L 29/00; C05F 5/00; C05F 11/00

(52) U.S. Cl. CPC A23K 10/37; A23K 20/111; C05F 11/00; A23L 29/035; C05F 5/002; A23K 40/10

(57) ABSTRACT

A granular solid composition is disclosed, comprising at least one tannin and vegetable natural fiber, said composition being for animal feed and agriculture. A process for preparing said granular solid composition is also described

### FIELD OF INVENTION

The present invention relates to a granular solid composition comprising at least one tannin and vegetable natural fiber, said composition being for animal feed and agriculture. A process for preparing said granular solid composition is also described.

### STATE OF THE ART

Polyphenols are a heterogeneous group of natural substances, particularly known for their positive effect on human health. In nature, polyphenols are produced by the secondary metabolism of plants, where, depending on the chemical diversity characterizing them, they play different roles: defense against herbivores (impart unpleasant taste) and pathogens (phytoalexins), mechanical support (lignins) and barrier against microbial invasion, attraction of pollinators and dispersal of fruits (anthocyanins), growth inhibitors of competing plants.

Under the chemical point of view, polyphenols are molecules composed of more condensed phenolic cycles. Depending on their structure, they can be schematically divided into three different classes, simple phenols, flavonoids and tannins. Tannins can be used in animal feed. In fact, the quality of bovine origin foods, such as meat, milk and cheese, is strongly influenced by the animal feed. In particular, it was recently possible to improve the nutritional value, changing the rumen microbial metabolism, by introducing tannins into the diet (max 4% of dry matter). The several positive effects are:
prevention (bloating, intestinal parasitosis, dismetabolia for urea synthesis, fertility);
increase in abomasal protein stream;
absorption of essential amino acids in the small intestine level;
milk enriched in polyunsaturated fat;
bright color flesh.

Similar effects were found on sheep. In the case of poultry, the ability to control infection by Clostridium perfringens was observed.

In agriculture, however, the tannins are used as fertilizers. In fact, owing to their ability to bind to nitrogen compounds, they have proved to be able to modify the release of nitrogen, to increase the recovery of phosphorus with starter effect and complexing trace elements such as iron and zinc.

The richest sources of tannins is the bark of trees such as oak, chestnut, pine, acacia. Despite the advantages outlined above, the use of tannins is limited by the difficulty of workability and handling of the same, as when in contact with solvents such as water form a compact and cohesive mass, hardly disintegrating and therefore not usable. It is therefore felt the need to overcome this drawback, in order to take advantage of the multiple properties of tannins.

It is therefore an object of the present invention to provide an economical and effective solution to the problem of poor workability and handling of tannins.

### SUMMARY OF THE INVENTION

Said object has been achieved by a granular solid composition comprising at least one tannin and vegetable natural fiber, as reported in claim 1.

For the purposes of the present invention, with the term “granular” or “granules”, it is meant that the solid composition is in the form of powder, micro-tablets, granules, micro-granules, micro-pellets, multiparticulate, micronized particulate or a mixture thereof. For the purposes of the present invention, with the expression “vegetable natural fiber”, it is meant fiber of coconut, pineapple, kapok, bran cereal, preferably corn bran, sunflower, rapeseed, or a mixture thereof.

In particular, said fiber may be advantageously a byproduct deriving for example from pressing coconut or pineapple, as well as deriving from the processing of their mesocarp. Preferably, vegetable natural fibers are have an average length not higher than 3 mm. In another aspect, the present invention relates to a process of preparation of said granular solid composition.

In another aspect, the present invention relates to a granular solid composition, obtainable by said process.

In a further aspect, the present invention relates to the use of said granular solid composition as an ingredient in animal feed.

In a still further aspect, the present invention relates to the use of said granular solid composition as a fertilizing agent in agriculture.

The characteristics and advantages of the present invention will become apparent from the following detailed description and embodiments provided by way of illustrative and not limitative examples.

### DETAILED DESCRIPTION OF THE INVENTION

The invention thus relates to a granular solid composition comprising at least one tannin and vegetable natural fiber.

Tannins are compounds with intermediate or high molecular weight, which can reach 30,000 Dalton. They are highly hydroxylated molecules and can form insoluble complexes with carbohydrates and proteins.

Tannins can be split into three groups: hydrolysable, complex and condensated. A hydrolysable tannin is a gallic tannin (or gallotannin), i.e. an ester of gallic acid and glucose, or an ellagic tannin (or ellagitannin), i.e. an ester of hexahydroxydiphenic acid (or ellagic acid) and glucose. These tannins are easily hydrolysable in the presence of acids, bases, or enzymes.

A complex tannin is constituted by a flavan-3-ol glycosidically linked to a unit of gallic or ellagic tannin. It is only partially hydrolysed.

A condensed tannin (or proanthocyanidin) is a high molecular weight polymer and not immediately hydrolysable. The monomer units composing the same mainly are flavan-3-ol, being flavan-3,4-diol a precursor thereof. The oxidative condensation occurs between the carbon C-4 and the carbon C-6 or C-8 of the adjacent units.

The condensed tannins are classified according to their pattern of hydroxylation, for example procyanidin (3,5,7,3′,4′-OH), prodelphinidin (3,5,7,3′,4′,5′-OH), propelargonidin (3,5,7,4-OH), profisetinidin (3,7,3′,4′-OH), prorobinetidin (3,7,3′,4′,5′-OH), proguibourtinidin (3,7,4′-OH), proteracacinidin (3,7,8,4′-OH), promelacacinidin (3,7,8,3′,4′-OH). Procyanidins, in turn, can be classified according to the number of subunits and bond types: for example, procyanidin A (dimer), procyanidin B (dimer), procyanidin C (trimer), procyanidins D (tetramer).

For the purposes of the present invention, said at least one tannin is a hydrolysable tannin, a complex tannin, a condensed tannin, or a combination thereof.

Preferably, the granular solid composition of the invention comprises granules comprising an intimate mixture of said tannin and said vegetable natural fiber and optionally a total residual water content not higher than 20% by weight on the weight of the composition.

Preferably, the weight ratio between tannin and vegetable natural fiber is 50:1 to 1:5. However, since for the purposes of animal feed and agriculture, the tannin is the component of interest, preferably, the weight ratio between tannin and vegetable natural fiber is higher than 1.

In preferred embodiments, the weight ratio between tannin and vegetable natural fiber is 30:1 to 1.5:1.

In particularly preferred embodiments, the weight ratio between tannin and vegetable natural fiber is 25:1 to 2:1.

Preferably, said vegetable natural fiber is fiber of coconut, corn bran or a mixture thereof. In preferred embodiments, said vegetable natural fiber is fiber of coconut.

Preferably, the granular solid composition of the invention has an average particle size distribution D₅₀ of 0.4 to 5.0 mm. For the purposes of the present invention, this parameter is measured by an optical technique, such as laser diffraction (also called “classical light scattering”) or dynamic analysis of the images.

In preferred embodiments, the composition of the invention includes granules having average D50 particle size distribution of 500-1200 microns.

In some embodiments, the granular solid composition of the invention comprises granules consisting of an intimate mixture of said tannin and said vegetable natural fiber, and optionally a total residual water content not higher than 20% by weight on the weight of the composition.

Preferably, the granular solid composition of the invention comprises a total residual water content not higher 15% by weight on the weight of the composition.

The total residual water content can depend on the type of vegetable natural fiber selected. In fact, the coconut or pineapple fiber as a by-product of pressing has a total residual content of water higher than cereal bran and coconut or pineapple fiber deriving from their mesocarp.

In preferred embodiments, the granular solid composition of the invention comprises a total residual water content not higher than 10% by weight on the weight of the composition.

In another aspect, the present invention relates to a process for the preparation of the granular solid composition described above, comprising the steps of:
a) providing at least one tannin,
b) providing a vegetable natural fiber,
c) joining said at least one tannin and vegetable natural fiber in a granulator by mixing in the presence of water until granules are obtained,
d) drying the granules obtained down to a water content of less than 20% by weight on the weight of the granules.

The above process advantageously allows to obtain a granular solid composition which is compact, free-flowing and dust-free, so as to be easily handled and dosed.

In some embodiments, said granulator is a batch granulator.

Preferably, the said granulator is a fluid-bed granulator.

More preferably, said granulator is a batch fluid-bed granulator.

In other embodiments, in step c), the weight ratio between water and the sum of the amounts of said at least one tannin and vegetable natural fiber is 1:1 to 1:20, preferably from 1:1 to 1:15.

In further embodiments, a binding agent is dissolved in water in order to further improve the final cohesion of the granules. Preferably, an aqueous solution at 2-10% by weight of binding agent is used, more preferably 3-6% by weight of binding agent.

Said binding agent may advantageously be the same at least one tannin of step a). In this way, the final granules are enriched in tannin content and thus more valuable, as well as more cohesive.

Alternatively, said binding agent can be starch, modified starch, starch phosphate, pectin, modified pectin, amylopectin, alginic acid, sodium alginate, guar gum, guar flour, tragacanth, gum arabic, xanthan gum, karaya gum, tara gum, tamarind gum, gellan gum, locust bean gum, gelatin, carob seed flour, galactomannan, glucomannan, dextran, carrageenan, mannan, arabinogalactan, pullulan, maltodextrin, cellulose, derivatized cellulose, carboxymethyl cellulose, sodium carboxymethyl cellulose, soy polysaccharide, chitosan, or a mixture thereof.

The binding agent is chosen according to the intended use of the granular solid composition, therefore, if the latter is to be used in animal feed, the binding agent is acceptable from the alimentary point of view.

In this regard, when the granular solid composition is for animal feed, it may optionally include additional components, such as vitamins, mineral salts, proteins, amino acids, trace elements, lubricants or mixtures thereof.

Said lubricants are preferably calcium stearate or magnesium stearate.

On the other hand, when the granular solid composition is for agriculture, it is not necessary that any binding agent be acceptable from the alimentary point of view; therefore, suitable binding agents can also be lignin sulphonates, hydrolysated lignosulphonates, halogenated lignin sulphonates, lignosulphonates nitrates, oxidized lignin sulphonates, lignosulphonates dehydrogenated, lignosulphonates desulphonated, or mixtures thereof.

In this regard, when the granular solid composition is for agriculture, it may optionally include additional components, such as macro-elements, i.e. nitrogen, phosphorus and potassium, trace elements, for example iron, magnesium, sulfur, copper, boron, molybdenum, zinc, manganese, and molybdenum, nutrients, stimulants for growth and flowering, anti-block agents, anti-dust agents, or a mixture thereof.

In first embodiments, the granules of the granulated solid composition of the invention comprise an intimate mixture of said at least one tannin, said vegetable natural fiber, optionally said further components, and optionally said binding agent.

In the second embodiments, the granular solid composition of the invention comprises granules consisting of an intimate mixture of said at least one tannin, said vegetable natural fiber, and optionally said binding agent, and optionally comprises said further components.

This means that in the first embodiments, all the components are granulated together, therefore granules are obtained which include all the selected components, whereas in the second embodiments, granules consist of at least one tannin, vegetable natural fiber and optionally a binding agent, being further components added separately.

Moreover, the present invention concerns the use of the granular solid composition as an ingredient for food products intended for animal feed. In fact, the possibility offered by the present invention to provide tannin in granules, allows taking advantage of the presence of the same in food.

The present invention therefore also relates to a food product intended for animal feed comprising the granular solid composition described above.

Finally, the present invention concerns the use of the granular solid composition as a fertilizing agent in agriculture. In fact, as said, tannins are able to modify the release of nitrogen, to increase the recovery of phosphorus with starter effect and to complex trace elements such as iron and zinc.

The present invention therefore also relates to a granular fertilizer comprising the solid composition described above.

It is to be understood that all aspects identified as preferred and advantageous for the composition are deemed to be similarly preferred and advantageous also for the preparation process, and its uses.

It should be understood also that all the combinations of preferred aspects and embodiments of the composition, of the preparation process, and its uses, are to be deemed as hereby disclosed.

The invention has therefore made it possible to effectively and conveniently overcome the difficulties of workability and handling of tannins that limited its use so far. In view of the surprising properties demonstrated by the association of at least one tannin and vegetable natural fiber, further tests were carried out that have confirmed the possibility of working said at least one tannin in further solid forms.

The present invention therefore also relates to a solid composition comprising at least one tannin and vegetable natural fiber, said solid composition being in the form of tablet, mini-tablet, pellet, or extrudate.

These additional solid forms may be obtained by methods known in the art, such as, for example, by using tableting machine for compression.

Preferably, said solid composition is in the form of tablet.

Preferably, in said solid forms, the weight ratio between tannin and vegetable natural fiber is 50:1 to 2:1.

In preferred embodiments, the weight ratio between tannin and vegetable natural fiber is from 25:1 to 15:1.

In other embodiments, said solid composition comprises at least 90% by weight of at least one tannin, on the weight of the composition.

In further embodiments, said solid composition comprises up to 10% by weight of vegetable natural fiber, on the weight of the composition.

The solid forms listed above showed an advantageously high capability of disaggregation and dissolution in aqueous solution, even when said solid forms exhibit high hardness.

Preferably, said solid forms have a hardness of 40-70 N, more preferably 50-60 N. This is a particularly significant advantage, especially considering that a high hardness facilitates the transfer and transport, but in this case surprisingly without compromising the high capacity of disaggregation and dissolution in aqueous solution. As demonstrated in Examples reported below, the solid forms of the invention proceed to complete disaggregation in less than 40 minutes by immersion in aqueous solution, preferably in less than 30 minutes.

In preferred embodiments, said solid composition, either granular or in one of the forms provided above, further includes a veterinary active agent, selected from a drug, a food supplement, a bacterium, a probiotic microorganism, or a combination thereof.

In preferred embodiments, said solid composition, either granular or in one of the forms provided above, is at least partially coated with a controlled release coating material; preferably, said solid composition is completely coated with the controlled release coating material.

Preferably, said controlled release coating material comprises ethylcellulose, hydroxypropylmethylcellulose, hydroxypropylcellulose, hydroxyethylcellulose, Carbopol, salts of alginic acid, xanthan gum, carboxymethylcellulose or its salts, polyvinyl alcohol, polymethacrylates, polyvinyl acetate, or a mixture thereof.

Preferably, said controlled release coating material comprises an enteric polymer.

Preferably, said enteric polymer is selected from the group consisting of cellulose acetate phthalate, cellulose acetate succinate, hydroxypropylmethylcellulose phthalate, hydroxypropylmethylcellulose acetate succinate, polyvinyl acetate phthalate, hydroxyethyl cellulose phthalate, cellulose acetate tetrahydrophthalate, methacrylate-methacrylic acid copolymers, methyl methacrylate-methacrylic acid copolymers, sodium alginate, stearic acid, their salts and mixtures thereof.

Preferably, the controlled release coating material is in an amount up to 10% by weight on the weight of the solid composition coated.

It is to be understood that all aspects identified as preferred and advantageous for the granular solid composition and its uses, are also analogously to be deemed preferred and advantageous for the solid composition in the form of tablet, mini-tablet, pellet, or extrudate.

It should be understood also that all the combinations of preferred aspects and embodiments of the composition, of the preparation process, and its uses, as reported above, are to be deemed as hereby disclosed.

Below are working examples of the present invention provided for illustrative purposes.

### EXAMPLES

In the Examples, the following components have been used, after having sieved the same and recovered the fraction under 250 μm:

Tannin

| | | |
|---|---|---|
| Ellagic tannin content on the dry substance | Min | 75% |
| Humidity | Max | 8% |
| pH (10%) | | 3.5 ± 0.3 |
| Ash | Max | 1.8% |

Fiber of Coconut

| | | |
|---|---|---|
| Lignin | | 35-70% |
| Cellulose | | 23-40% |
| Hemicellulose | | 3-12% |
| pH | | 5.5 ± 1 |
| Porosity (% v/v) | | 90 ± 5 |
| Available water (% v/v) | Max | 37% |

Corn bran

| | |
|---|---|
| Energetic value per 100 g (calories) | 224 kcal |
| Proteins | 8.36% |
| Carbohydrates | 85.60% |
| Sugars | 0% |
| Fats | 0.92% |
| saturated | 0.13% |
| monounsaturated | 0.24% |
| polyunsaturated | 0.42% |
| Cholesterol | 0% |
| Food fiber | 79% |
| Sodium | 0.007% |

### Example 1

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 100 g | 200 g | 1:2 | 300 g | 100 g | 3:1 | 400 g |

where
‘Ratio FC/T’ is the ratio between the amount of Fiber of Coconut and the amount of Tannin;
‘TOT Solid’ is the sum of the amounts of Fiber of Coconut and Tannin; ‘Ratio S/W’ is the ratio between the amounts of Solid and Water

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

This demonstrated that the combination with fiber of coconut surprisingly allows granulating tannin, so as to make it suitable for use both in animal feed and in agriculture, being the granule a form which is easy to be handled and dosed.

A sieving was then performed, while retaining the fraction of 0.5 mm to 1.2 mm.

### Example 2

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 50 g | 450 g | 1:9 | 500 g | 100 g | 5:1 | 600 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.7 mm to 1.0 mm.

### Example 3

Granules were prepared by setting the following amounts:

| | | | TOT | | | |
|---|---|---|---|---|---|---|
| Corn Bran | Tannin | Ratio CM/T | Solid | Water | Ratio S/W | TOTAL |
| 100 g | 400 g | 1:4 | 500 g | 100 g | 5:1 | 600 g |

where ‘Ratio CM/T’ is the ratio between the amount of Corn Bran and the amount of Tannin

In a batch granulator, corn bran and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.5 mm to 1.0 mm.

### Example 4

Granules were prepared by setting the following amounts:

| | | Ratio | | | | |
|---|---|---|---|---|---|---|
| Corn Bran | Tannin | CM/T | TOT Solid | Water | Ratio S/W | TOTAL |
| 200 g | 800 g | 1:4 | 1000 g | 300 g | 3.3:1 | 1300 g |

In a batch granulator, corn bran and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.8 mm to 1.2 mm.

### Example 5

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 50 g | 950 g | 1:19 | 1000 g | 1000 g | 1:1 | 2000 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.5 mm to 1.0 mm.

### Example 6

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 50 g | 950 g | 1:19 | 1000 g | 1500 g | 1.5:1 | 2500 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 2.0 mm to 4.0 mm.

### Example 7

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 50 g | 950 g | 1:19 | 1000 g | 2000 g | 2:1 | 3000 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 1.5 mm to 3.0 mm.

### Example 8

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 50 g | 950 g | 1:19 | 1000 g | 2500 g | 2.5:1 | 3500 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.5 mm to 1.0 mm.

### Example 9

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 100 g | 1900 g | 1:19 | 2000 g | 500 g | 4:1 | 2500 g |

In a batch granulator, fiber of coconut and water were initially introduced. Tannin was then added by mixing in order to promote the formation of granules.

The obtained granules were then transferred on paper towels and dried.

Both the appearance and the cohesion of the granules were satisfactory.

A sieving was then performed, while retaining the fraction of 0.5 mm to 1.0 mm.

### Example 10

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 1670 g | 3330 g | 1:2 | 5000 g | 500 g | 10:1 | 5500 g |

A batch granulator 7-liter (mod. GRV7 marketed by LB Officine Meccaniche S.p.A., IT) was used, by setting the following operating conditions:
bar rotation speed: 2000 rpm
reactor rotation speed: 1270 rpm
rotation direction of the two rotating elements: discordant.

The granulation was carried out at room temperature for a total time of about 5-6 minutes.

The granules obtained were then transferred and dried in a stove at a temperature of 35° C.

Both the appearance and the cohesion of the granules were satisfactory.

### Example 11

Granules were prepared by setting the following amounts:

| Fiber of | | | TOT | | | |
|---|---|---|---|---|---|---|
| Coconut | Tannin | Ratio FC/T | Solid | Water | Ratio S/W | TOTAL |
| 2.5 kg | 22.5 kg | 1:9 | 25 kg | 4 kg | 6.25:1 | 29 kg |

A batch fluid bed granulator (mod. AERBED marketed by VIANI s.n.c., IT) was used. The process temperature was set at 35° C. and about 4 kg of water were used on the whole, considering that this amount strongly depends on the aspiration applied to the fluid bed. Granulation lasted for about 50 minutes.

The granules obtained were then transferred and dried in a stove at a temperature of 35° C. Both the appearance and the cohesion of the granules were satisfactory.

Other tests were also carried out by using, instead of water, a solution of 5% by weight of tannin and a solution of 5% by weight of food grade arabic gum.

In both cases, very cohesive granules were obtained.

### Example 12

Tablets, mini-tablets, and micro-tables were prepared, having the following composition:

94.5% by weight of Tannin

4.5% by weight of Fiber of coconut

Hardness: 50N

### Example 13

Tablets, mini-tablets, and micro-tables were prepared, having the following composition:

94.5% by weight of Tannin

4.5% by weight of Fiber of coconut

1% by weight of calcium stearate and/or magnesium stearate

Hardness: 55N

### Example 14

Tablets, mini-tablets, and micro-tables were prepared, having the following composition:

87.5% by weight of Tannin

4.17% by weight of Fiber of coconut

0.93% by weight of calcium stearate and/or magnesium stearate

7.4% by weight of ethylcellulose

Hardness: 60N

### Example 15

The tablets of Example 12 and the coated tablets of Example 14 were subjected to a disaggregation test.

The test was performed in accordance with the conditions laid down in section 2.9 of the Official Italian Pharmacopoeia (XII Ed.), as follows.

This test is intended to determine whether the tablets, when placed in a liquid medium under the test conditions indicated, will disaggregate within the prescribed time. For the purpose of this test, the disaggregation does not imply the complete dissolution of the pharmaceutical form unit subjected to the test nor the complete dissolution of its active component. By definition, the disaggregation is complete when all the residue consists of a soft mass, without hard palpable nucleus.

Method. Introducing, in each of the six tubes of the basket, a unit of the pharmaceutical form under test. Switching on the apparatus while using, as an immersion liquid, the means specified, maintained at 37° C.±2° C. After the indicated time, lifting the basket from the liquid and examining the state of the units under test.

In the tests performed on the tablets of Examples 12 and 14, 800 mL of buffer pH 3.5 was used as the immersion liquid, being prepared according to European Pharmacopoeia 8^{th} Ed., whose composition is:
KH₂PO₄ 0.5 M
H₃PO₄ up to pH 3,5

Results:

Tablets of Example 12: as soon as they are immersed in the buffer, they begin to release small fragments of brown color, which over time increase and tend to settle to the bottom. In all the samples, the tablets begin to disaggregate at 24 minutes, and the disaggregation is complete within 30 minutes.

Tablets of Example 14: The tablets were stable when immersed in a buffer. At about 30 minutes, small holes were observed at the edges of the tablet (probably where the film thickness is lower) from which the dark brown color of the inner tablet is visible, but no release is noted for 180 minutes.

1. A granular solid composition comprising at least one tannin and a vegetable natural fiber.

2. The granular solid composition of claim 1, comprising granules comprising an intimate mixture of said at least one tannin and said vegetable natural fiber and optionally an overall residual content of water not higher than 20% by weight on the weight of the composition.

3. The granular solid composition of claim 1 or 2, wherein said vegetable natural fiber is fiber of coconut.

4. The granular solid composition of claim 3, wherein the weight ratio between tannin and vegetable natural fiber is 30:1 to 1.5:1, preferably 25:1 to 2:1.

5. The granular solid composition of claim 1, comprising granules consisting of an intimate mixture of said at least one tannin and said vegetable natural fiber, and optionally an overall residual content of water not higher than 20% by weight on the weight of the composition.

6. Process for preparing the granular solid composition of claim 1, comprising the steps of:
a) providing at least one tannin,
b) providing a vegetable natural fiber,
c) joining said at least one tannin and vegetable natural fiber in a granulator by mixing in the presence of water until granules are obtained,
d) drying the granules obtained down to a water content of less than 20% by weight on the weight of the granules.

7. The process of claim 6, wherein, in step c), the weight ratio between water and the sum of the amounts of said at least one tannin and vegetable natural fiber is 1:1 to 1:20, preferably 1:1 to 1:15.

8. The process of claim 6, wherein a ligand agent is dissolved in the water of step c).

9. An ingredient for food products intended for animal feed, said ingredient comprising the granular solid composition of claim 1.

10. A fertilizing agent for agriculture comprising the granular solid composition of claim 1.

11. The granular solid composition of claim 1, wherein said granular solid composition further comprises a veterinary active agent, selected from a drug, a food supplement, a bacterium, a probiotic microorganism, or a combination thereof.

12. The granular solid composition of claim 1, wherein said granular solid composition is at least partially coated with a controlled release coating material, said controlled release coating material preferably being in an amount up to 10% by weight on the weight of the solid composition coated.

13. The granular solid composition of claim 12, wherein said controlled release coating material comprises an enteric polymer.

14. A solid composition comprising at least one tannin and a vegetable natural fiber, said solid composition being in the form of tablet, mini-tablet, pellet, or extrudate.

15. The solid composition of claim 14, wherein the weight ratio between tannin and vegetable natural fiber is 50:1 to 2:1, preferably 25:1 to 15:1.

16. The solid composition of claim 14, wherein said solid composition comprises at least 90% by weight of at least one tannin, on the weight of the composition.

17. The solid composition of claim 14, wherein said solid composition comprises up to 10% by weight of vegetable natural fiber, on the weight of the composition.

18. The solid composition of claim 14, wherein said solid composition has a hardness of 40-70 N, preferably 50-60 N.

19. The solid composition of claim 14, wherein said solid composition further comprises a veterinary active agent, selected from a drug, a food supplement, a bacterium, a probiotic microorganism, or a combination thereof.

20. The solid composition of claim 14, wherein said solid composition is at least partially coated with a controlled release coating material, said controlled release coating material preferably being in an amount up to 10% by weight on the weight of the solid composition coated.

21. The solid composition of claim 20, wherein said controlled release coating material comprises an enteric polymer.
